(19) United States
(12) Patent Application Publication
(10) Pub. No.: US 2025/0050821 A1
(43) Pub. Date: Feb. 13, 2025

(54) VEHICLE EXTERIOR COMPONENT

(71) Applicant: TOYODA GOSEI CO., LTD., Kiyosu-shi (JP)

(72) Inventors: Yuta KIMURA, Kiyosu-shi (JP); Kozo HIROTANI, Kiyosu-shi (JP); Kazuki TAKAO, Kiyosu-shi (JP); Kimihiro IIMURA, Kiyosu-shi (JP)

(21) Appl. No.: 18/771,801

(22) Filed: Jul. 12, 2024

(30) Foreign Application Priority Data
Aug. 10, 2023 (JP) 2023-131016

(51) Int. Cl. B60R 13/00; H05B 3/06

(52) U.S. Cl. CPC B60R 13/005; H05B 3/06

(57) ABSTRACT

A vehicle exterior component includes a main body and a heater unit that is provided in the main body. The main body includes a base made of a plastic and a frame portion. The base includes a base body and an outer projecting portion that projects from an outer periphery of the base body. The frame portion includes a frame body and an inner projecting portion. The heater unit includes an extension that is disposed between an inner surface of the outer projecting portion and an outer surface of the inner projecting portion, and a connector pin. The inner projecting portion includes a base portion and a support projection. Fitting structures that engage with each other are provided on the inner surface of the outer projecting portion and on an outer surface of the base portion.

### CROSS-REFERENCE TO RELATED APPLICATIONS

This application is based upon and claims the benefit of priority from prior Japanese Patent Application No. 2023-131016, filed on Aug. 10, 2023, the entire contents of which are incorporated herein by reference.

### BACKGROUND

### 1. Field

The present disclosure relates to a vehicle exterior component.

### 2. Description of Related Art

Japanese Laid-Open Patent Publication No. 2022-114858 discloses a vehicle exterior component. This vehicle exterior component includes a decorative main body, which decorates a vehicle, and a heater sheet, which generates heat when energized.

The decorative main body includes a base defining the back-side portion of the decorative main body, a transparent plastic layer defining the front-side portion of the decorative main body, and a decorative layer arranged between the transparent plastic layer and the base.

The base includes a base body portion and a frame portion. The base body portion is made of a plastic of acrylonitrile-ethylene-styrene (AES) copolymer. A socket portion is formed integrally with a lower part of the base body portion. A plug of a device used to supply power is inserted into the socket portion. The frame portion is made of a mixed material of polycarbonate (PC) plastic and carbon black. The frame portion includes a loop portion extending along the outer periphery of the base body portion and a projecting portion, which projects from the lower part of the loop portion toward the back side. The projecting portion is embedded in the socket portion.

The heater sheet includes a heating main body, which is stacked on the front side of the decorative main body, and an extension, which extends from a lower part of the heating main body toward the back side. A part of the extension is embedded between the socket portion and the projecting portion of the frame portion.

In such a vehicle exterior component, repeated power supply and cutoff to the heater sheet causes the socket portion and frame portion to undergo repeated thermal expansion and thermal shrinkage. Since the socket portion and the frame portion are made of plastic materials with different coefficients of linear expansion, stress concentrates on one of the socket portion and the frame portion. Consequently, there is a risk of deformation of the stressed portion.

It is an objective of the present disclosure to provide a vehicle exterior component that limits deformation of parts.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle exterior component includes a main body and a heater unit that is provided in the main body and is configured to heat the main body. The main body includes a base made of a plastic and a frame portion that extends along an outer periphery of the base and is made of a plastic material having a coefficient of linear expansion different from that of the base. The base includes a base body and an outer projecting portion that projects from an outer periphery of the base body. A direction in which the outer projecting portion projects is defined as a projecting direction. The frame portion includes a frame body and an inner projecting portion that projects in the projecting direction from the frame body and is embedded in the outer projecting portion. The heater unit includes a heater body that covers the base body, an extension that extends from the heater body and is disposed between an inner surface of the outer projecting portion and an outer surface of the inner projecting portion, and a connector pin that is electrically connected to the extension and projects further than the extension in the projecting direction. The inner projecting portion includes a base portion and a support projection that projects from the base portion along the connector pin to support the connector pin. Fitting structures that engage with each other are provided on the inner surface of the outer projecting portion and on an outer surface of the base portion.

Other features and aspects will be apparent from the following detailed description, the drawings, and the claims.

### BRIEF DESCRIPTION OF THE DRAWINGS

FIG. 1 is a schematic diagram showing an emblem and a radar device in a vehicle exterior component according to an embodiment.

FIG. 2 is a front view of the emblem shown in FIG. 1.

FIG. 3 is a cross-sectional view taken along line 3-3 of FIG. 2.

FIG. 4 is a cross-sectional view taken along line 4-4 of FIG. 3.

FIG. 5 is a rear view showing a heater unit in the emblem shown in FIG. 2.

FIG. 6 is a cross-sectional view taken along line 6-6 of FIG. 3.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

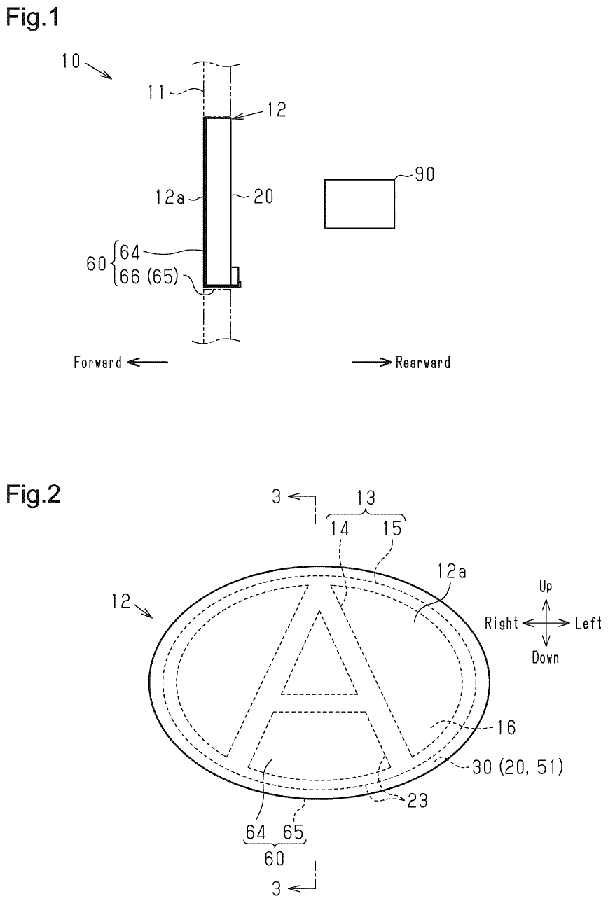

A vehicle exterior component according to an embodiment will now be described with reference to FIGS. 1 to 6. In the present embodiment, the present disclosure is employed as an emblem attached to the front part of a vehicle.

In the following description, the ‘forward’ and ‘rearward’ in the longitudinal direction of a vehicle will simply be referred to as ‘forward’ and ‘rearward’. Also, the ‘upward’ and ‘downward’ in the vertical direction of the vehicle when the vehicle is located on a horizontal plane will simply be referred to as the ‘upward’ and ‘downward’, respectively.

### Emblem 12

As shown in FIGS. 1 and 2, a radar device 90 is mounted on a vehicle front part 10. The radar device 90 emits and receives electromagnetic waves. The radar device 90 emits electromagnetic waves having a wavelength of 1 mm to 10 mm and a frequency of 30 GHz to 300 GHz, or millimeter waves, toward the front of the vehicle.

An emblem 12 is attached to a portion 11 that defines the outer shape of the vehicle front part 10. The emblem 12 covers the radar device 90 from the front and permits passage of millimeter waves.

The front surface of the emblem 12 forms a decorative surface 12a. For illustrative purposes, the side on which the decorative surface 12a is located may be referred to as a front side, and the side opposite to the decorative surface 12a may be referred to as a back side.

The emblem 12 includes a decorative main body 20 and a heater unit 60, which is provided on the decorative main body 20 and heats the decorative main body 20.

Each component will now be described.

### Decorative Main Body 20

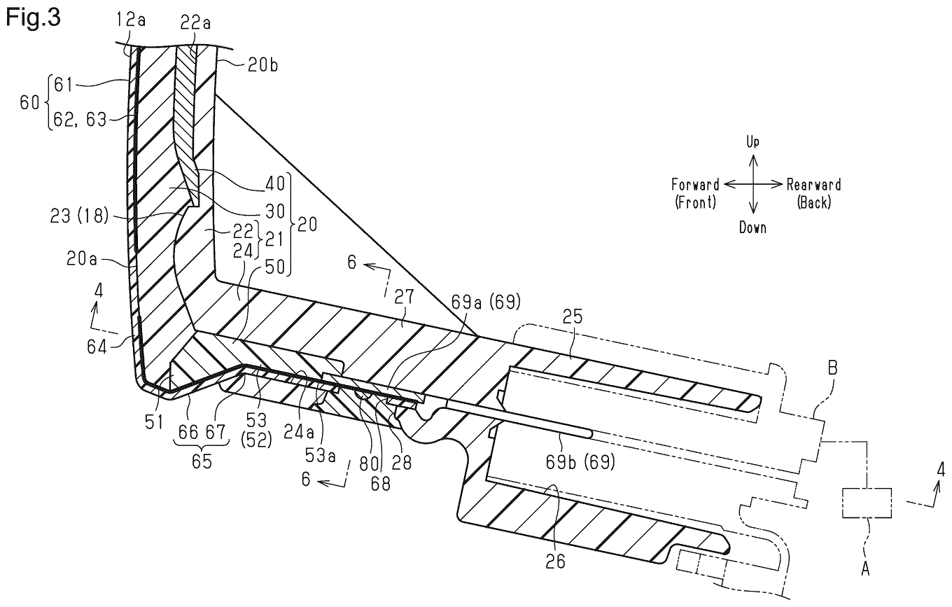

As shown in FIGS. 2 and 3, the decorative main body 20 includes a base 21, a transparent plastic layer 30, a decorative layer 40, and a frame portion 50.

### Base 21

The base 21 is made of a colored plastic material. The plastic material may be, for example, polycarbonate (PC) plastic, acrylonitrile-ethylene-styrene copolymer (AES) plastic, acrylonitrile-styrene-acrylate copolymer (ASA) plastic, or polymer alloy of PC plastic and acrylonitrile-butadiene-styrene copolymer (ABS) plastic. In the present embodiment, the base 21 is made of PC plastic.

The base 21 includes a base body 22 and an outer projecting portion 24, which projects from the outer periphery of the base body 22.

The base body 22 includes a back surface 20b of the decorative main body 20. A protrusion 23, which projects forward, is formed on a front surface 22a of the base body 22. The protrusion 23 is provided at a position corresponding to a pattern area 13 of the emblem 12 (refer to FIG. 2). The pattern area 13 includes a character portion 14, which forms a letter “A”, and a loop portion 15, which extends along the outer periphery of the decorative surface 12a of the emblem 12. The portion of the front surface 22a excluding the protrusion 23 corresponds to a background area 16, which is a portion of the emblem 12 excluding the pattern area 13.

The outer projecting portion 24 is bent and extends from the outer periphery of the base body 22 toward the back side. In the following description, the direction in which the outer projecting portion 24 projects will be referred to as a projecting direction.

The outer projecting portion 24 includes a socket portion 25 and an intermediate portion 27, which is located between the base body 22 and the socket portion 25.

The socket portion 25 is a portion into and from which a plug B of a device A, which is a power supply (indicated by the long-dash double-short-dash lines in FIG. 3), is inserted and removed. The socket portion 25 has a socket 26, which opens rearward. When the plug B is inserted into the socket 26 of the socket portion 25, the heater unit 60 is electrically connected to the device A.

The intermediate portion 27 includes a window 28, which opens downward.

### Transparent Plastic Layer 30

As shown in FIGS. 2 and 3, the transparent plastic layer 30 covers the front surface 22a of the base body 22 from the front and forms a front surface 20a of the decorative main body 20.

The transparent plastic layer 30 is made of a transparent plastic material. The plastic material may be, for example, a transparent plastic such as PC plastic or polymethyl methacrylate (PMMA) plastic. In the present embodiment, the transparent plastic layer 30 is made of PC plastic. In the present embodiment, the term transparent includes not only colorless transparent, but also colored transparent.

### Decorative Layer 40

As shown in FIG. 3, the decorative layer 40 is located between the base body 22 and the transparent plastic layer 30. The decorative layer 40 permits passage of millimeter waves. The decorative layer 40 is composed by combining a colored decorative layer, which has a deep color such as black or blue, and a lustrous decorative layer, which is made of metal such as indium (In).

### Frame Portion 50

The frame portion 50 is made of a colored plastic material. Specifically, the frame portion 50 is formed in black with a mixed material in which a plastic material and a black pigment such as carbon black are mixed. As the plastic material, AES plastic (coefficient of linear expansion: 0.85) is used, which has a larger coefficient of linear expansion than PC plastic (coefficient of linear expansion: 0.7) forming the base material 21.

As shown in FIG. 3, the frame portion 50 includes a frame body 51 and an inner projecting portion 52. The frame body 51 extends along the outer periphery of the base 21. The inner projecting portion 52 projects in the projecting direction from the frame body 51.

The frame body 51 has a loop shape extending along the outer peripheries of the base body 22 and the transparent plastic layer 30 (refer to FIG. 2).

The inner projecting portion 52 extends in the projecting direction toward the back side and is embedded in the outer projecting portion 24.

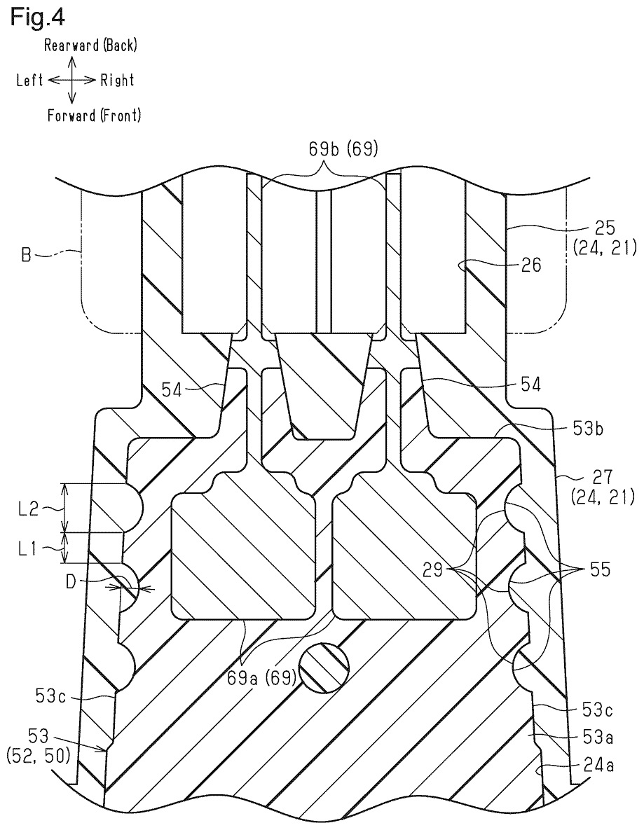

As shown in FIG. 4, the inner projecting portion 52 includes a base portion 53, two support projections 54 projecting from the base portion 53, and recesses 55.

The base portion 53 is a rectangular plate having long sides extending in the projecting direction. In the following description, a direction extending parallel to the short sides will be referred to as a width direction of the base portion 53 (lateral direction in FIG. 4).

The two support projections 54 are located on a surface of the outer surface 53a of the base portion 53 that extends along the short side, that is, on a surface 53b at the backmost position in the projecting direction. The two support projections 54 extend in the projecting direction. The two support projections 54 are arranged in the width direction while being spaced apart from each other.

The recesses 55 are semicircular in plan view. Each recess 55 has a concave bottom surface curved with respect to the projecting direction. The recesses 55 are provided on each of side surfaces 53c of the outer surface 53a of the base portion 53 that extend along the long sides. In the present embodiment, each side surface 53c has three of the recesses 55. The recesses 55 are arranged in the projecting direction while being spaced apart from each other. A length L1 of the distance between the recesses 55 is less than a length L2 of each recess 55 in the projecting direction. Specifically, the length L1 is preferably set to be less than or equal to 1.3 mm (0 mm<L1≤1.3 mm). Also, a depth D of each recess 55 in the width direction is preferably set to be greater than or equal to 0.5 mm (D≥0.5 mm).

The outer projecting portion 24 includes engagement protrusions 29 on an inner surface 24a at positions corresponding to the recesses 55. The engagement protrusions 29 are engaged with the recesses 55. The engagement protrusions 29 correspond to the protrusions according to the present disclosure. The recesses 55 and the engagement protrusions 29 form fitting structures according to the present disclosure.

### Heater Unit 60

As shown in FIGS. 3, 5, and 6, the heater unit 60 includes a sheet base 61 and two heating wires 62, 63.

The sheet base 61 is made of a transparent plastic material such as PC plastic.

The heating wires 62, 63 are made of a metal that generates heat when energized, and are routed on the back surface of the sheet base 61.

The heater unit 60 includes a heater body 64, an extension 65, and connector pins 69.

The heater body 64 covers the front surface 20a of the decorative main body 20 from the front and forms the decorative surface 12a of the emblem 12 (refer to FIG. 3). In other words, the heater body 64 covers the base body 22 from the front.

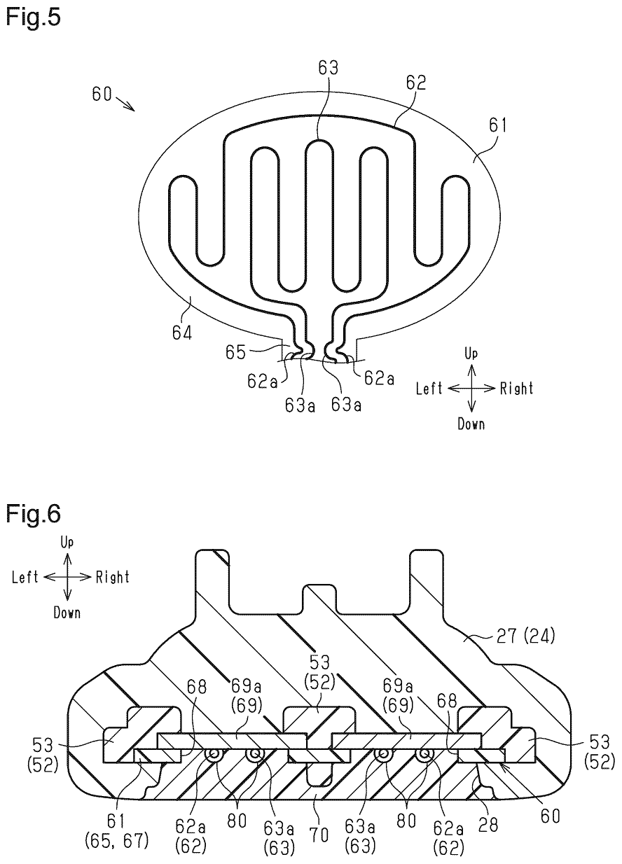

In the heater body 64, the heating wires 62, 63 are routed in different patterns (refer to FIG. 5).

As shown in FIGS. 3 and 6, the extension 65 is bent and extends from the outer periphery of the heater body 64 toward the back side in the projecting direction.

The extension 65 includes an exposed portion 66 and an embedded portion 67.

The exposed portion 66 extends from the outer periphery of the heater body 64 along the transparent plastic layer 30 and the frame body 51.

The embedded portion 67 extends further toward the back side from the exposed portion 66 and is embedded between the inner surface 24a of the outer projecting portion 24 and the outer surface 53a of the base portion 53 of the inner projecting portion 52.

The embedded portion 67 includes two openings 68, which respectively expose the heating wires 62, 63 downward from the window 28 at positions corresponding to the window 28. The two openings 68 are spaced apart from each other in the width direction (lateral direction in FIG. 6).

The heating wires 62, 63 include terminal portions 62a, 63a, which are arranged in the embedded portion 67. The terminal portions 62a, 63a are electrically connected to the connector pins 69, which extend in the projecting direction. Specifically, the terminal portions 62a, 63a are joined to the connector pins 69 by performing soldering in the openings 68. FIGS. 3 and 6 show joint portions 80, which are made of a solder alloy and formed through soldering. The above-described joining does not necessarily need to be performed by soldering, but may be performed by welding, crimping, or adhesion using an electrically conductive adhesive.

A water stop portion 70 is arranged in the window 28 to restrict entrance of water into the joint portions of the terminal portions 62a, 63a and the connector pins 69. The water stop portion 70 is formed by filling the window 28 with a plastic material.

As shown in FIGS. 3, 4, and 6, the present embodiment includes two connector pins 69. The connector pins 69 are arranged in the width direction (lateral direction in FIG. 6) while being spaced apart from each other.

The connector pins 69 each include a flat plate portion 69a and rod portion 69b, which extends in the projecting direction toward the back side from the flat plate portion 69a.

The flat plate portions 69a are embedded between the outer projecting portion 24 and the inner projecting portion 52.

The rod portions 69b project further in the projecting direction toward the back side than the extension 65. The basal ends of the rod portions 69b are supported by the support projections 54. The distal ends of the rod portions 69b are arranged in the socket 26.

Operation of the present embodiment will now be described.

Repeated power supply and cutoff to the heater unit 60 cause the outer projecting portion 24 and the inner projecting portion 52 to undergo repeated thermal expansion and thermal shrinkage. At this time, since the engagement protrusions 29 and the recesses 55, which are provided on the inner surface 24a of the outer projecting portion 24 and the outer surface 53a of the base portion 53 of the inner projecting portion 52, are engaged with each other, the stress acting on the inner surface 24a and the outer surface 53a is dispersed. This limits concentration of stress on specific parts in the inner surface 24a and the outer surface 53a.

The present embodiment has the following advantages.

(1) The engagement protrusions 29 and the recesses 55, which are fitting structures engaging with each other, are provided on the inner surface 24a of the outer projecting portion 24 and the outer surface 53a of the base portion 53.

The above-described configuration operates in the above-described manner. This limits deformation of the parts of the emblem 12.

(2) The fitting structures include the recesses 55 and the engagement protrusions 29, which engage with the recesses 55.

With this configuration, the fitting structures including the recesses 55 and the engagement protrusions 29, which engage with each other, disperse the stress acting on the inner surface 24a of the outer projecting portion 24 and the outer surface 53a of the base portion 53 of the inner projecting portion 52. This limits concentration of stress on specific parts in the inner surface 24a and the outer surface 53a. This limits deformation of the parts of the emblem 12 more effectively.

(3) The base portion 53 is a rectangular plate having long sides extending in the projecting direction. The recesses 55 are provided on the two side surfaces 53c of the outer surface 53a of the base portion 53 that extend along the long sides. The recesses 55 are arranged in the projecting direction while being spaced apart from each other.

If the base portion 53 of the inner projecting portion 52 had the shape of a rectangular plate having long sides extending in the projecting direction, the inner projecting portion 52 would easily thermally expand and thermally shrink in the projecting direction. In this regard, the above-described configuration includes the recesses 55, which are provided on the two side surfaces 53c of the base portion 53 and are arranged in the projecting direction while being spaced apart from each other. Thus, the stress acting on the inner surface 24a of the outer projecting portion 24 and the outer surface 53a of the base portion 53 of the inner projecting portion 52 due to thermal expansion and thermal shrinkage is more appropriately dispersed by the fitting structures, which include the recesses 55 and the engagement protrusions 29. This limits deformation of the components of the emblem 12 in a favorable manner.

(4) The length L1 of the distance between the recesses 55 is less than the length L2 of each recess 55 in the projecting direction.

As described above, the recesses 55 are arranged in the two side surfaces 53c of the outer surface 53a of the base portion 53 while being spaced apart from each other by a distance in the projecting direction. In this case, if the length of the base portion 53 in the projecting direction is constant, an increase in the distance between the recesses 55 results in a fewer number the recesses 55. As a result, the stress acting on the inner surface 24a of the outer projecting portion 24 and the outer surface 53a of the base portion 53 of the inner projecting portion 52 would be less likely to be dispersed. In this regard, with the above-described configuration, the length L1 of the distance between the recesses 55 is less than the length L2 of each recess 55 in the projecting direction. This configuration promotes dispersion of the stress.

### Modifications

The above-described embodiment may be modified as follows. The above-described embodiment and the following modifications can be combined as long as the combined modifications remain technically consistent with each other.

The number of the heating wires in the heater unit 60 is not limited to two as described in the above-described embodiment, but may be one or more than two. In this case, the routing configuration of the heating wires is not limited to that illustrated in FIG. 5 of the above-described embodiment and may be changed in correspondence with the specification of the emblem 12.

The heater unit 60 may be arranged at any position if the heater body 64 covers the base body 22. For example, in the above-described embodiment, the heater unit 60 includes the heater body 64 that covers the front surface 20a of the decorative main body 20 from the front. Instead, the heater body 64 may cover the back surface 20b of the decorative main body 20 from behind. In this case, the extension 65 may extend from the outer periphery of the heater body 64 through the base 21, and be embedded between the inner surface 24a of the outer projecting portion 24 and the outer surface 53a of the base portion 53 of the inner projecting portion 52.

The length L1 of the distance between the recesses 55 does not necessarily need to be less than the length L2 of each recess 55 in the projecting direction, as in the above-described embodiment. For example, the length L1 may be greater than or equal to the length L2 (L1≥L2).

The shape of each recess 55 does not necessarily need to be semicircular in plan view as in the above-described embodiment. For example, each recess 55 may have a bottom surface and two side surfaces that rise from the opposite ends of the bottom surface.

The shape of the inner projecting portion 52 is not limited to the one in the above-described embodiment. For example, the base portion 53 may be rectangular and elongated in the width direction. In this case, the recesses 55 need to be provided at positions in the surface 53b that do not overlap with the support projections 54, and the engagement protrusions 29, which engage with the recesses 55, need to be provided on the inner surface 24a of the outer projecting portion 24.

With this configuration, the recesses 55 and the engagement protrusions 29 are engaged with each other, and the support projections 54 are engaged with the inner surface 24a of the outer projecting portion 24. That is, the above-described advantage (3) is achieved by cooperation of the fitting structures, which include the recesses 55 and the engagement protrusions 29, and the support projections 54. This limits deformation of the components of the emblem 12 in a further favorable manner.

The fitting structures according to the present disclosure are not limited to the ones described in the above-described embodiment, which include the recesses 55 of the inner projecting portion 52 and the engagement protrusions 29 of the outer projecting portion 24. For example, recesses may be provided in the inner surface 24a of the outer projecting portion 24, and protrusions that engage with the recesses may be provided in the outer surface 53a of the base portion 53 of the inner projecting portion 52, in addition to the support projections 54.

The number and arrangement of the fitting structures according to the present disclosure may be changed. For example, fitting structures may be provided over the entire outer surface 53a of the base portion 53.

The vehicle exterior component according to the present disclosure is not limited to a vehicle exterior component in which the base 21 is made of a PC plastic and the frame portion 50 is made of a mixture of an AES plastic and carbon black as exemplified in the above-described embodiment. The base 21 and the frame portion 50 may be made of any plastic material as long as the base 21 and the frame portion 50 are made of plastic materials having different coefficients of linear expansion. For example, the base 21 may be made of an AES plastic, and the frame portion 50 may be made of a mixture of a PC plastic and carbon black.

The vehicle exterior component according to the present disclosure is not limited to the emblem 12 described in the above-described embodiment. The present disclosure may be employed as any vehicle exterior component that decorates a vehicle, such as an ornament, a mark, a grille, and a decorative component.

The vehicle exterior component according to the present disclosure is not limited to the configuration including the decorative layer 40. That is, the decorative layer 40 may be omitted. In other words, the present disclosure is not limited to a vehicle exterior component that decorates a vehicle, and may be employed as a vehicle exterior component that simply forms the vehicle outer shape, such as a bumper or a cover.

The vehicle exterior component according to the present disclosure is not limited to the configuration in front of the radar device 90, which emits and receives millimeter waves. For example, the vehicle exterior component according to the present disclosure may be installed in a vehicle equipped with a device that emits and receives electromagnetic waves to detect an outside object, and may include a heater unit on the front side of the main body. In this case, the electromagnetic waves emitted and received by the radar device 90 include, for example, infrared rays in addition to millimeter waves.

The position of the vehicle exterior component according to the present disclosure is not limited to the vehicle front part 10 and may be changed as long as the vehicle exterior component is arranged in front of a radar device that emits and receives electromagnetic waves used to detect an object outside the vehicle. When the radar device is used to monitor the situation behind the vehicle, for example, the vehicle exterior component is located frontward from the radar device in the emission direction of electromagnetic waves and rearward from the radar device in the longitudinal direction of the vehicle. The same applies to a case in which the radar device monitors the situation on the sides of the front part of the vehicle, or the situation on the sides of the rear part of the vehicle.

The vehicle exterior component according to the present disclosure may be installed in a vehicle that is not equipped with a radar device that emits and receives electromagnetic waves to detect an outside object.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior component, comprising:
a main body; and
a heater unit that is provided in the main body and is configured to heat the main body, wherein
the main body includes:
a base made of a plastic; and
a frame portion that extends along an outer periphery of the base and is made of a plastic material having a coefficient of linear expansion different from that of the base,
the base includes:
a base body; and
an outer projecting portion that projects from an outer periphery of the base body,
a direction in which the outer projecting portion projects is defined as a projecting direction,
the frame portion includes:
a frame body; and
an inner projecting portion that projects in the projecting direction from the frame body and is embedded in the outer projecting portion,
the heater unit includes:
a heater body that covers the base body;
an extension that extends from the heater body and is disposed between an inner surface of the outer projecting portion and an outer surface of the inner projecting portion; and
a connector pin that is electrically connected to the extension and projects further than the extension in the projecting direction,
the inner projecting portion includes:
a base portion; and
a support projection that projects from the base portion along the connector pin to support the connector pin, and
fitting structures that engage with each other are provided on the inner surface of the outer projecting portion and on an outer surface of the base portion.

2. The vehicle exterior component according to claim 1, wherein the fitting structures include recesses and protrusions that engage with the recesses.

3. The vehicle exterior component according to claim 2, wherein
the base portion is a rectangular plate having long sides extending in the projecting direction, and
the recesses are provided on two side surfaces of the outer surface of the base portion that extend along the long sides and are arranged in the projecting direction while being spaced apart from each other.

4. The vehicle exterior component according to claim 3, wherein a distance between the recesses is less than a length of each recess in the projecting direction.
